(19) United States
(12) Patent Application Publication
(10) Pub. No.: US 2025/0336632 A1
(43) Pub. Date: Oct. 30, 2025

(54) Device, System And Method For Closing A Fuse Cutout

(71) Applicant: Pepco Holdings LLC, Washington, DC (US)

(72) Inventor: Jamie Wegner, Delmar, DE (US)

(21) Appl. No.: 18/650,911

(22) Filed: Apr. 30, 2024

(51) Int. Cl. H01H 71/66; H01H 85/055

(52) U.S. Cl. CPC H01H 71/66; H01H 85/055

(57) ABSTRACT

A load break cutout refuser includes an actuator configured to couple to a fuse cutout. A receiver is communicatively coupled to the actuator. The receiver is configured to receive a signal from a transmitter remote from the receiver. The actuator is configured to close the fuse cutout in response to the signal received by the receiver. A system includes the refuser and a transmitter remote from the fuse cutout, receiver, and actuator to send a signal to the receiver to cause the actuator to close the fuse cutout. A method of closing a fuse cutout using the load break cutout refuser system is also disclosed.

### FIELD

Disclosed herein is a device, system and method that may be used for closing a fuse cutout.

### BACKGROUND

FIGS. 1 and 2 show a conventional fuse cutout 10 used in electrical distribution. The fuse cutout 10 is a combination fuse and switch which protects distribution transformers from current surges and overloads. As shown in FIG. 1, the fuse cutout 10 comprises an insulator 20 having a first and second end 22, 24 oppositely disposed. A line-end connector 30 is coupled to the insulator body 20 proximate the first end 22. The line-end connector 30 is configured to connect the fuse cutout 10 to the overhead feeder line. A load-side connector 40 is coupled to the insulator body 20 proximate the second end 24. The load-side connector 40 is configured to connect the fuse cutout 10 to the primary of a distribution transformer. A top hood 32 and upper contact 34 are coupled to the line-end connector 30. A lower contact 42 is coupled to the load-side connector 40. A fuse tube 50 housing a fuse element (not visible) closes the circuit between the upper and lower contacts 34, 42. A first end 52 of the fuse tube 50 may be held closed via attachment hooks 60. A second end 54 of the fuse tube 50 is coupled to the second end of the insulator body 20 via a hinge connection 70.

When the current exceeds the rated value of the fuse element, the fuse element melts and breaks the circuit, disconnecting the transformer from the line to protect the transformer. When the fuse element melts or “blows,” the first end 52 of the fuse tube 50 is forced from the attachment hooks 60 and pivots away from the upper contact 34 via the hinge connection 70 so that the fuse tube 50 is in an open position and is hanging from the hinge connection 70 as shown in FIG. 2. The fuse tube 50, hanging from the hinge connection 70, provides a visible indication that the circuit is open. A technician may then replace the fuse element.

As shown in FIG. 3, after the fuse element is replaced, a technician 90 uses a hot stick or extenda stick 80 to create separation between the fuse tube 50 and the technician. The technician uses the tip 82 of the hot stick or extenda stick 80 to hook a pull ring 58 on the fuse tube 50 proximate the hot stick or extenda stick's first end 52. The technician then maneuvers the hot stick or extenda stick 80 to pivot the fuse tube 50 about the hinge connection 70 to close the circuit by pivoting the fuse tube 50 until the first end 52 of the fuse tube 50 engages the upper contact 34 and the fuse tube 50 is caught by the attachment hooks 60. Although the hot stick or extenda stick 80 provides a safer work environment by increasing the distance between the technician and the fuse cutout 10, there is still an inherent danger of a high energy electrical flash event when closing the fuse cutout 10. For example, a bad lightning arrestor, tracking cable, faulted/damaged terminators, transformer faults, animal contact faults or any other fault that remains on the circuit can create a large and high energy electrical arc flash event that could severely injure or even kill the technician.

There is clearly a need for a device, system and method used to close a fuse cutout that addresses one or more of these issues. For example, there is a need for a device, system and method used to close a fuse cutout that allows the technician to be at a safe distance to eliminate or greatly decrease the chance of injury or death to the technician due to an electrical arc flash event when closing the fuse cutout.

### SUMMARY

The disclosure concerns a load break cutout refuser. An example load break cutout refuser comprises an actuator configured to couple to a fuse cutout. A receiver is communicatively coupled to the actuator. The receiver is configured to receive a signal from a transmitter remote from the receiver. The actuator is configured to close the fuse cutout in response to the signal received by the receiver.

In one aspect, the actuator is configured to couple to a fuse tube of the fuse cutout.

In one aspect, the actuator is configured to move the fuse tube from an open position to a closed position. The fuse cutout is open and a load current is interrupted when the fuse tube is in the open positions. The fuse cutout is closed and the load current passes through the fuse cutout when the fuse tube is in the closed position.

In a further aspect, the refuser comprises a body configured to attach to the fuse cutout. An arm is pivotably attached to the body at a pivot pin. The actuator is coupled to the body. Optionally, the actuator is configured to cause the arm to pivot about the pivot pin. Optionally, the arm is coupled to the fuse tube and causes the fuse tube to simultaneously pivot with the arm from the open position to the closed position.

In one aspect, a first end of the arm is configured to couple to the fuse tube and a second end of the arm is coupled to at least one connecting member configured to couple the arm to the actuator. The pivot pin is positioned between the first end and the second end of the arm.

In one aspect, the actuator comprises a motor. Optionally, the motor is configured to rotate to effect rotation or pivotal movement of the at least one connecting member to pivot the arm.

The disclosure also concerns a load break cutout refuser system. An example load break cutout refuser system comprises an actuator configured to couple to a fuse cutout. A transmitter is remote from the fuse cutout. A receiver is communicatively coupled to the actuator and is configured to receive a signal from the transmitter. The actuator is configured to close the fuse cutout in response to the signal received by the receiver.

In one aspect, the actuator is configured to couple to a fuse tube of the fuse cutout.

In one aspect, the actuator is configured to move the fuse tube from an open position to a closed position. The fuse cutout is open and a load current is interrupted when the fuse tube is in the open position. The fuse cutout is closed and the load current passes through the fuse cutout when the fuse tube is in the closed position.

In one aspect, the transmitter is a component of a remote control.

In a further aspect, the refuser comprises a body configured to attach to the fuse cutout. An arm is pivotably attached to the body at a pivot pin. The actuator is coupled to the body. Optionally, the actuator is configured to cause the arm to pivot about the pivot pin. Optionally, the arm is coupled to the fuse tube and causes the fuse tube to simultaneously pivot with the arm from the open position to the closed position.

In one aspect, a first end of the arm is configured to couple to the fuse tube and a second end of the arm is coupled to at least one connecting member configured to couple the arm to the actuator. The pivot pin is positioned between the first end and the second end of the arm.

In one aspect, the actuator comprises a motor. Optionally, the motor is configured to rotate to effect rotation or pivotal movement of the at least one connecting member to pivot the arm.

The disclosure also concerns a method of closing a fuse cutout using the load break cutout refuser system disclosed herein. An example method comprises sending, by the transmitter, a signal to the receiver. The method comprises receiving, by the receiver, the signal. The method also comprises closing, by the actuator in response to the received signal, the fuse cutout.

### DESCRIPTION OF THE DRAWINGS

FIG. 1 shows an example fuse cutout in a closed position according to the prior art.

FIG. 2 shows an example fuse cutout in an open position according to the prior art.

FIG. 3 shows an example method of closing a fuse cutout according to the prior art.

FIG. 4 is a schematic of an example load break cutout refuser and an example load break cutout refuser system according to the disclosure.

FIGS. 5 to 7 show an example actuator coupled to an example fuse cutout.

FIGS. 8 and 9 show an example load break cutout refuser according to the disclosure coupled to an example fuse cutout in the open position.

FIG. 10 shows the example load break cutout refuser coupled to the fuse cutout of FIGS. 8 and 9 in a position before the fuse cutout in the closed position.

FIGS. 11 and 12 show the example load break cutout refuser coupled to the fuse cutout of FIGS. 8 and 9 in the closed position.

FIG. 13 shows a schematic of an example load break refuser system according to the disclosure.

FIG. 14 shows an example locking device.

### DETAILED DESCRIPTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only, and is not intended to limit the scope of the present invention.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

As used herein the singular forms “a,” “an,” and “the” include plural referents unless the context clearly dictates otherwise. For example, unless the context dictates otherwise, use of the term “a valve” can represent disclosure of embodiments in which only a single such valve is provided, as well as disclosure of embodiments in which a plurality of such valves are provided, and so forth.

All technical and scientific terms used herein have the same meaning as commonly understood to one of ordinary skill in the art to which this invention belongs unless clearly indicated otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. Optionally, in some aspects, when values are approximated by use of the antecedent “about,” it is contemplated that values within up to 15%, up to 10%, up to 5%, or up to 1% (above or below) of the particularly stated value can be included within the scope of those aspects. Similarly, in some optional aspects, when values are approximated by use of the terms “approximately,” “substantially,” or “generally,” it is contemplated that values within up to 15%, up to 10%, up to 5%, or up to 1% (above or below) of the particular value can be included within the scope of those aspects. When used with respect to an identified property or circumstance, “substantially” or “generally” can refer to a degree of deviation that is sufficiently small so as to not measurably detract from the identified property or circumstance, and the exact degree of deviation allowable may in some cases depend on the specific context.

As used herein, the terms “optional” or “optionally” mean that the subsequently described event or circumstance may or may not occur, and that the description includes instances where said event or circumstance occurs and instances where it does not.

The following description supplies specific details in order to provide a thorough understanding. Nevertheless, the skilled artisan would understand that the system and associated methods of using the system can be implemented and used without employing these specific details. Indeed, the system and associated methods can be placed into practice by modifying the illustrated apparatus and associated methods and can be used in conjunction with any other apparatus and techniques conventionally used in the industry.

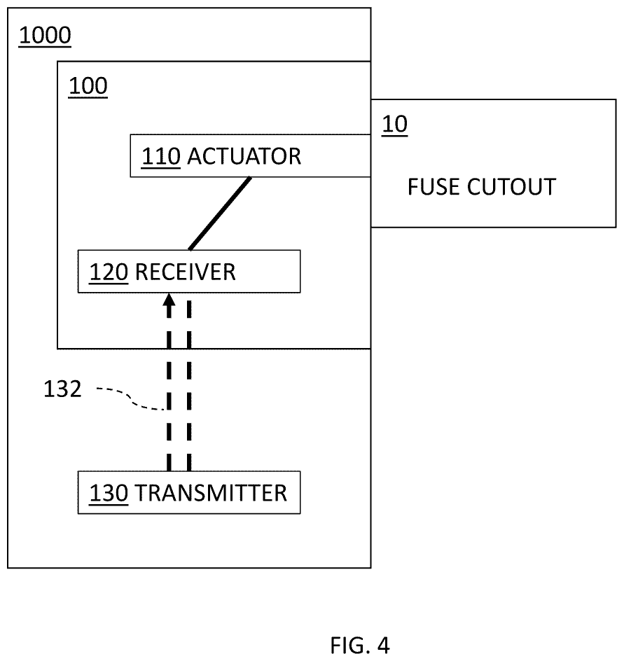

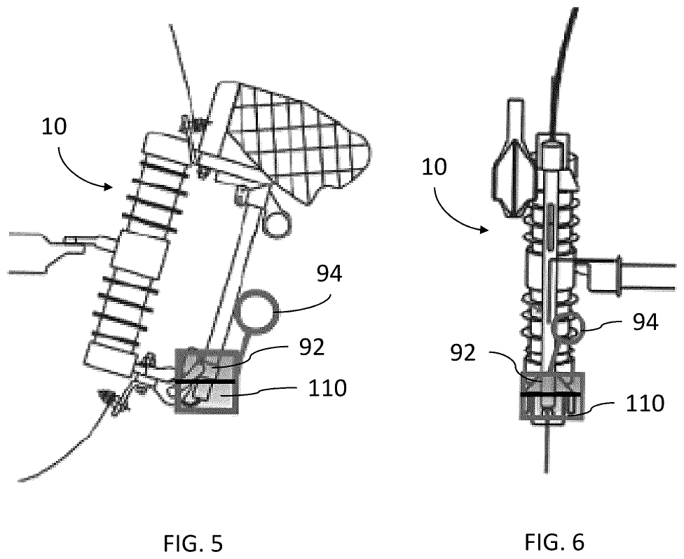

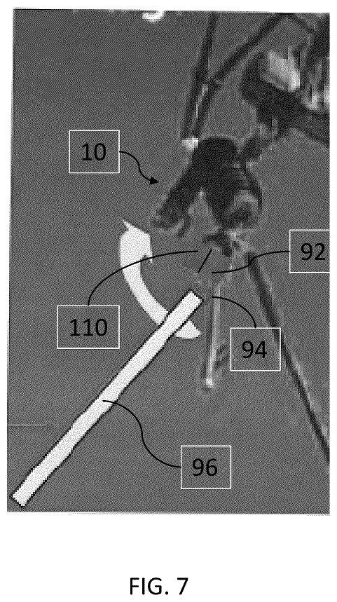

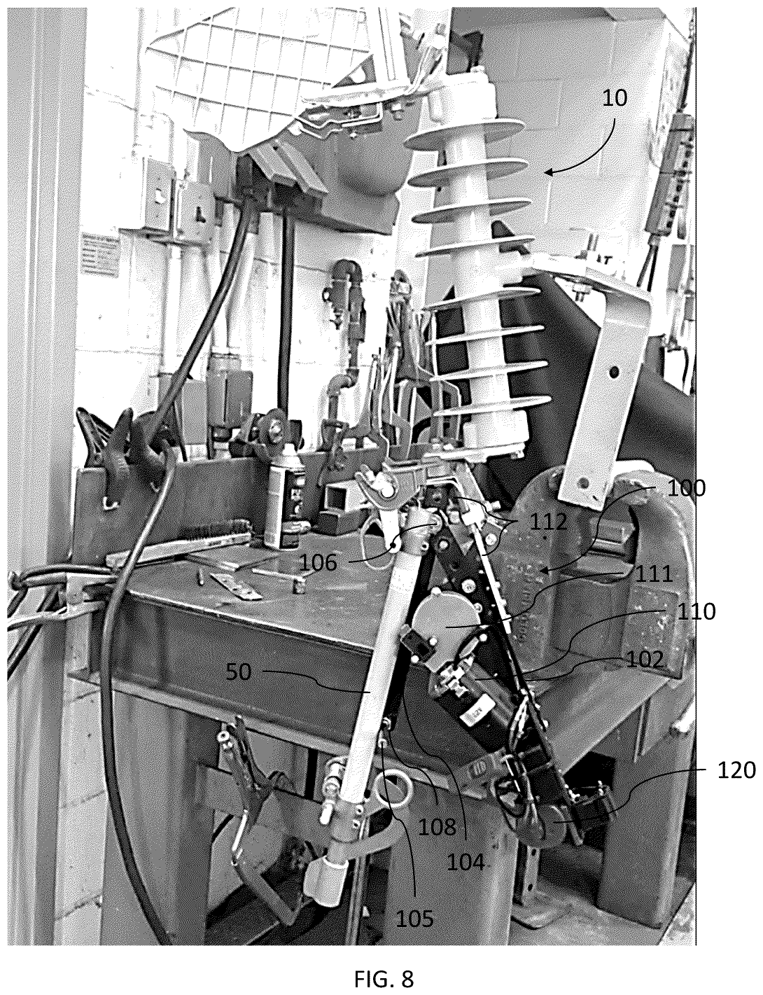

FIG. 4 shows an example load break cutout refuser 100. Optionally, the load break cutout refuser 100 may comprise a fiberglass casing. The load break cutout refuser 100 comprises an actuator 110 configured to couple to a fuse cutout 10. The actuator 110 may be configured to couple directly or indirectly to the fuse cutout 10. As shown in FIGS. 5 and 6, the actuator 110 may be coupled to the fuse cutout 10 via a clamp 92. The clamp 92 may be integral with the actuator 110 or may be a separate component that may be removably coupled to the actuator 110. Optionally, the clamp 92 may be a hotline style clamp. As shown in FIG. 7, the clamp 92 may comprise a ring 94 to allow a technician to couple the clamp 92 to the fuse cutout 10 (e.g., the fuse tube 50 or a linkage to the fuse tube as disclosed herein) with a shotgun style hot stick 96 as is known in the art. Exemplary actuators include electric actuators (e.g., electric rotary actuators), hydraulic actuators (e.g., hydraulic rotary actuators), pneumatic actuators (e.g., pneumatic rotary actuators), and the like. Exemplary actuators may be lightweight. Optionally, the actuator 110 may be or comprise a window regulator motor. A receiver 120 is communicatively coupled to the actuator 110. The receiver 120 is configured to receive a signal from a transmitter remote from the receiver 120. The actuator 110 is configured to close the fuse cutout 10 in response to the signal received by the receiver 120. In exemplary aspects, the receiver 120 can be communicatively coupled to or a component of the actuator 110. In exemplary aspects, the receiver 120 can comprise or be communicatively coupled to a programmable logic controller (PLC) or other suitable controller that is configured to effect specific movement of the actuator in response to the received signals from the transmitter.

As shown in FIG. 4, an example load break cutout refuser system 1000 comprises a load break cutout refuser 100 and a transmitter 130. The transmitter 130 is remote from the fuse cutout 10. The receiver 120 of the refuser 100 is configured to receive a signal 132 from the transmitter 130. Optionally, the transmitter 130 may be configured to transmit the signal 132 to the receiver 120 via a secure frequency wherein communication between the transmitter 120 and the receiver 120 is secure and interference from devices outside of the system 1000 is avoided. Optionally, in exemplary aspects, both the receiver 120 and the transmitter 130 can comprise respective wireless radios or transceivers that are configured to both send and receive signals. In some aspects, the receiver 120 can comprise a wireless radiofrequency receiver as is known in the art, and the transmitter 130 can comprise a wireless radiofrequency transmitter as is known in the art. In some aspects, the receiver 120 can comprise an infrared receiver as is known in the art, and the transmitter 130 can comprise an infrared transmitter as is known in the art. The actuator 110 of the refuser 100 is configured to close the fuse cutout 10 in response to the signal 132 received by the receiver 120.

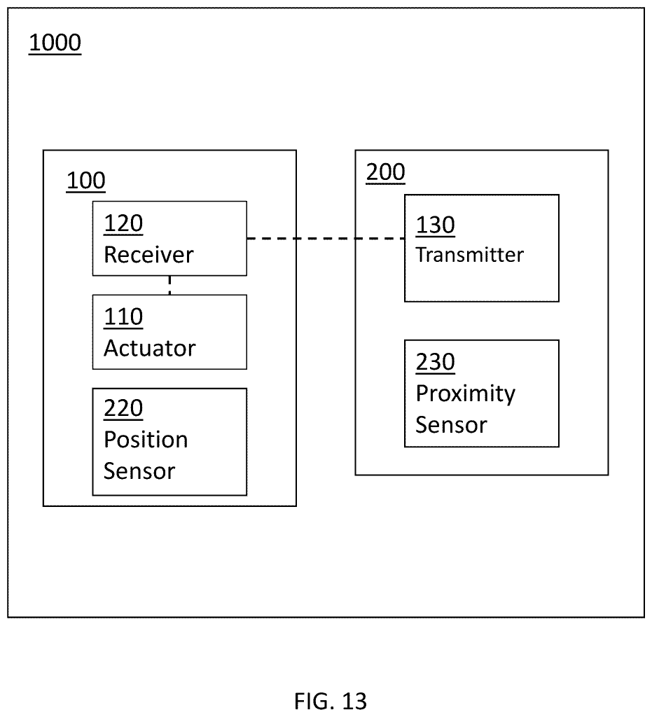

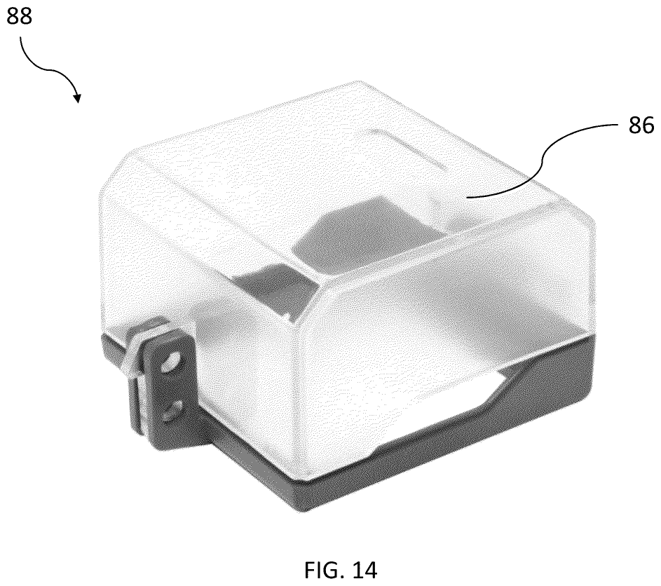

Optionally, as shown in FIG. 13, the transmitter 130 is a component of a remote control 200, which can include a communication unit that is operatively coupled to one or more user input devices, such as, for example, and without limitation, buttons, knobs, dials, a touchscreen, a microphone, or other structure for receiving inputs from a user indicative of instructions to open or close the fuse cutout as further disclosed herein. Optionally, the remote control comprises a power-on or arming button which is communicatively coupled to the transmitter 130. The remote control may further comprise a locking device configured to lock out the user to prevent the user from unintentionally causing the transmitter 130 to send the signal 132 to close the fuse cutout 10. Optionally, the locking device may be a standard lock out tag out device as is known in the art. FIG. 14 shows an example locking device 88. As shown in FIG. 14, the locking device 88 may comprise a flip-up lid 86 that is configured to lock in a closed position (e.g., by a pad lock) until the user is ready to engage an input device of the remote control and is fully aware of the action he or she is taking when pressing the button. In further exemplary aspects, the remote control can comprise a battery (e.g., a rechargeable battery) that can provide power to the hardware of the transmitter 130 and any associated input devices. Because the transmitter 130 is remote from the fuse cutout 10 and the refuser 100, a technician may couple the refuser 100 to the fuse cutout 10 and then safely position themselves safely on the ground. Once the technician is removed from the blast/flash zone of the potential arc flash, the transmission 130 may be used to the send a signal 132 to remotely close the refused fuse cutout 10 thereby significantly reducing the chance of injury or death of the technician due to an arc flash event.

As shown in FIG. 13, in a further aspect, the refuser 100 may comprise at least one position sensor 220 configured to determine whether the fuse cutout 10 is in the open or closed position. For example, the position sensor 220 may determine whether the position of a component of the refuser 100, for example the actuator or the fuse tube 50, corresponds to the open position of the fuse cutout 10 or the closed position of the fuse cutout 10. The at least one position sensor 220 may further increase the safety of the technician by letting the technician know whether the operation of closing the fuse cutout 10, and therefore the circuit, has been completed. Optionally, in a further aspect, the system 1000 may signal to the technician when the at least one position sensor 220 determines the closing operation is completed. Optionally, the signal may be an auditory signal or a visual signal on a user interface on the remote control 200.

Optionally, in a further aspect, at least one of the remote control 200 and the refuser 100 may comprise at least one proximity sensor 230 configured to determine the proximity of the refuser 100 to the remote control 200, and thus the technician. The at least one proximity sensor 230 may be used to disable the transmitter 130, the receiver 120, and/or the actuator 110 if the proximity of the refuser 100 and remote control 200 are within a predetermined distance to further ensure the technician is at a safe distance from the refuser 100 and fuse cutout 10 when the circuit is closed. For example, the refuser 100 may be prevented from closing the fuse cutout 10 if the sensor 230 determines the remote control 200 (and presumably the technician) are within 15 feet of the refuser 100. The position and/or proximity sensors may further increase the safety of the technician. Optionally, it is contemplated that position information as disclosed herein can be provided (e.g., wirelessly transmitted) to a display associated with the remote control 200.

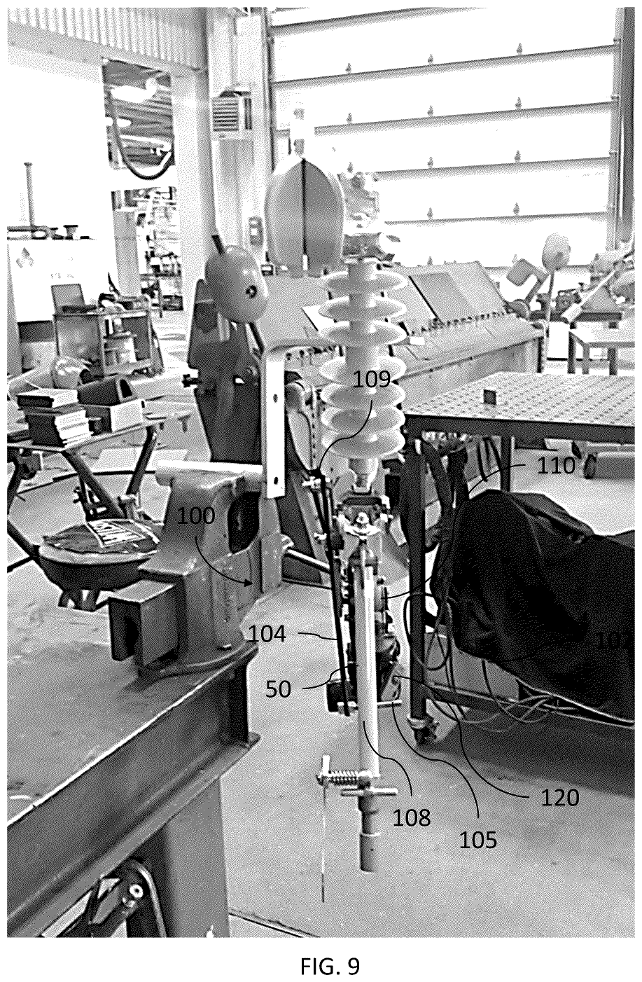

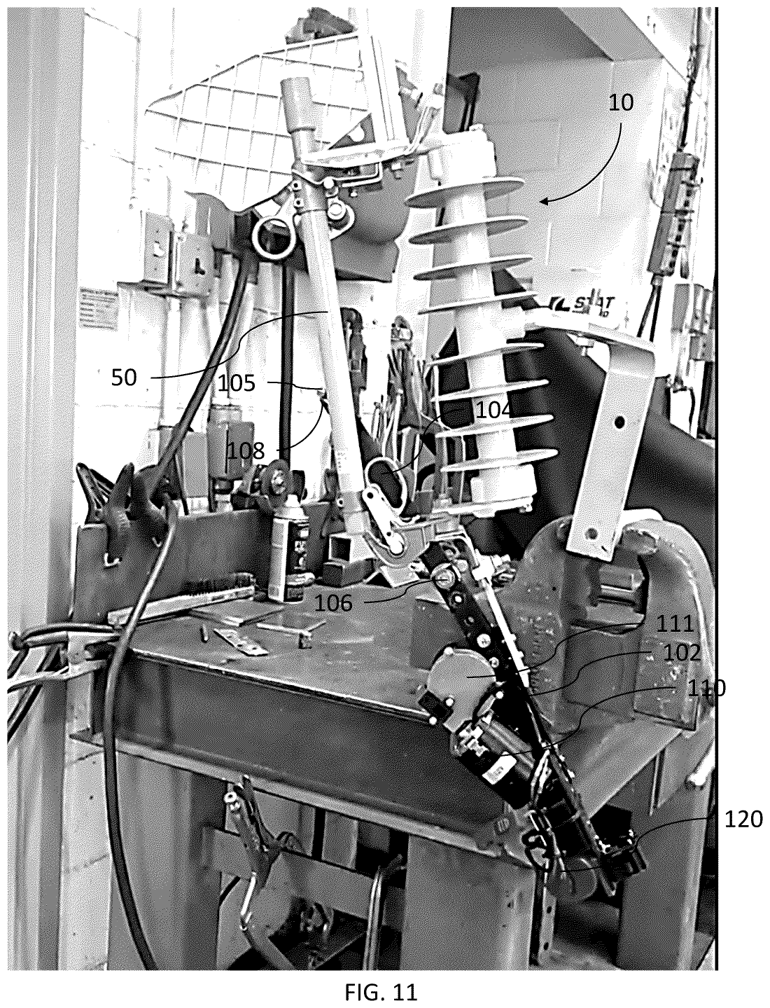

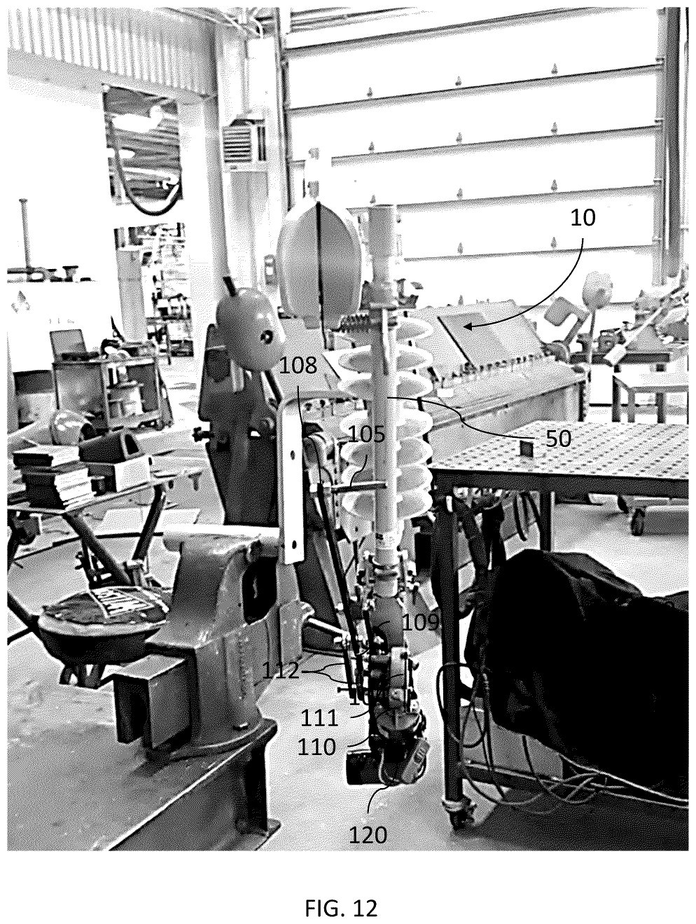

Optionally, the actuator 110 is configured to couple, either directly or indirectly to a fuse tube 50 of the fuse cutout 10. The actuator 110 may be configured to effect movement of the fuse tube 50 from an open position (shown in FIGS. 8 and 9) to a closed position (shown in FIGS. 11 and 12. The fuse cutout 10 is open and a load current is interrupted when the fuse tube 50 is in the open positions. The fuse cutout 10 is closed and the load current passes through the fuse cutout 10 when the fuse tube 50 is in the closed position.

As shown in FIGS. 8-12, the refuser 100 may comprise a body 102 configured to attach, either directly or indirectly to the fuse cutout 10. Optionally, the body 102 may be configured to attach to the fuse cutout 10 via a clamp. Further, the clamp may be integral with the body 102 or may be a separate component that may be removably coupled to the body 102. The clamp may be a hotline style clamp used with a shotgun style hot stick as is known in the art. An arm 104 may be pivotably attached to the body 102 at a pivot pin 106. The actuator 110 may be coupled to the body 102. The actuator 110 may be configured to cause the arm 104 to pivot about the pivot pin 104. The arm 104 may be coupled to the fuse tube 50 and cause the fuse tube 50 to simultaneously pivot with the arm 104 from the open position (shown in FIGS. 8 and 9) to the closed position (shown in FIGS. 11 and 12). A first end 108 of the arm 104 may be configured to couple to the fuse tube 50. Optionally, the arm 104 may be coupled to the fuse tube 50 via a pin 105 configured to engage the fuse tube 50. A second end 109 of the arm 104 may be coupled to at least one connecting member 112 configured to couple the arm 104 to the actuator 110. The pivot pin 106 may be positioned between the first end and the second end of the arm.

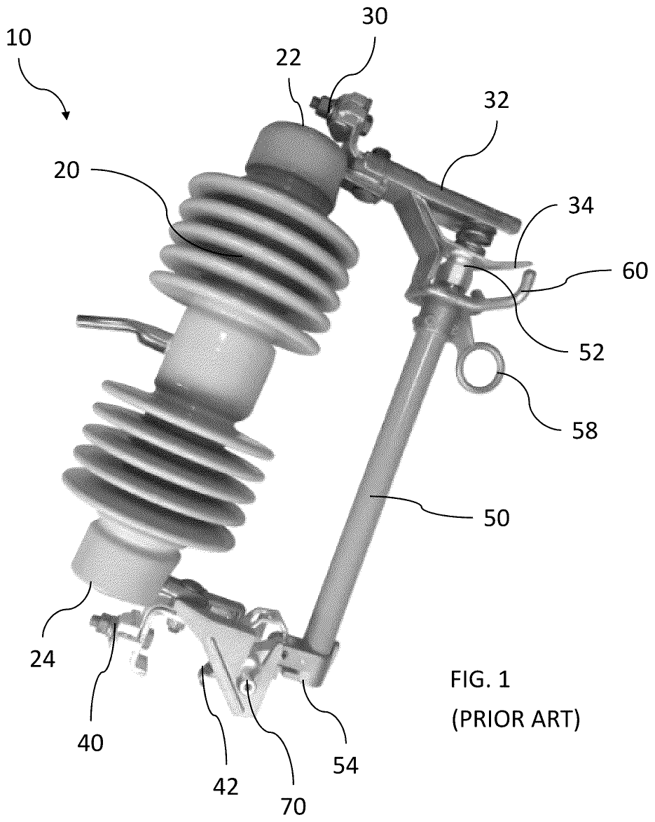

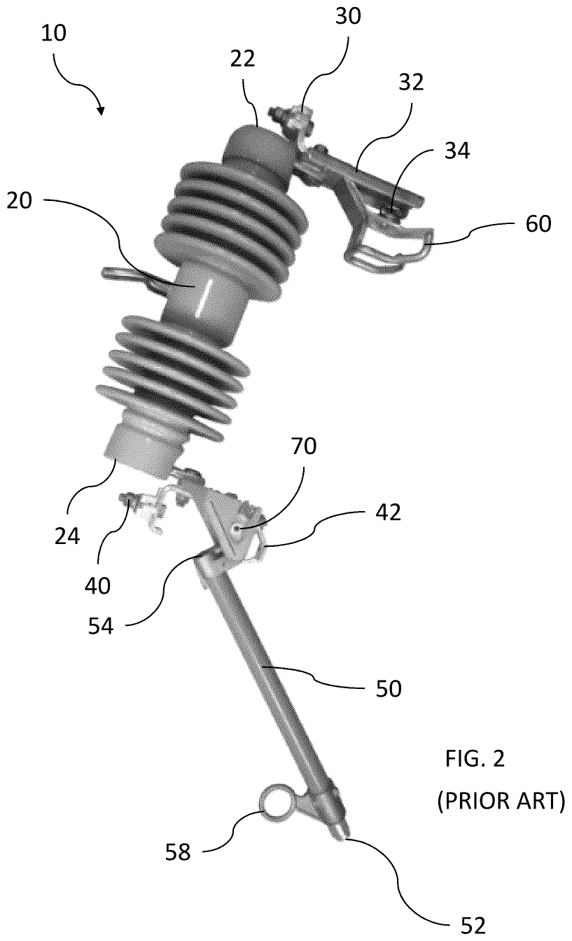

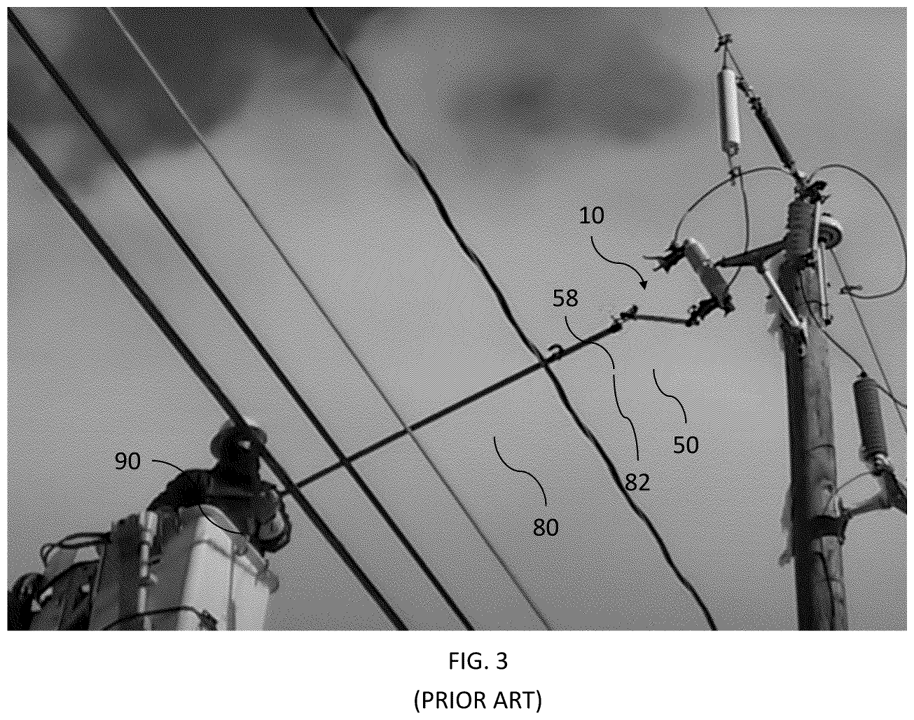

In additional or alternative aspects, it is contemplated that the fuse cutout 10 disclosed in FIGS. 1-3 can be modified to include an actuator 110 and a receiver 120 as disclosed herein. For example, in these aspects, it is contemplated that the actuator 110 can be operatively coupled to the hinge connection 70 of the fuse cutout and/or the second end 54 of the fuse tube 50 to effect pivotal movement of the fuse tube from the open position to the closed position.

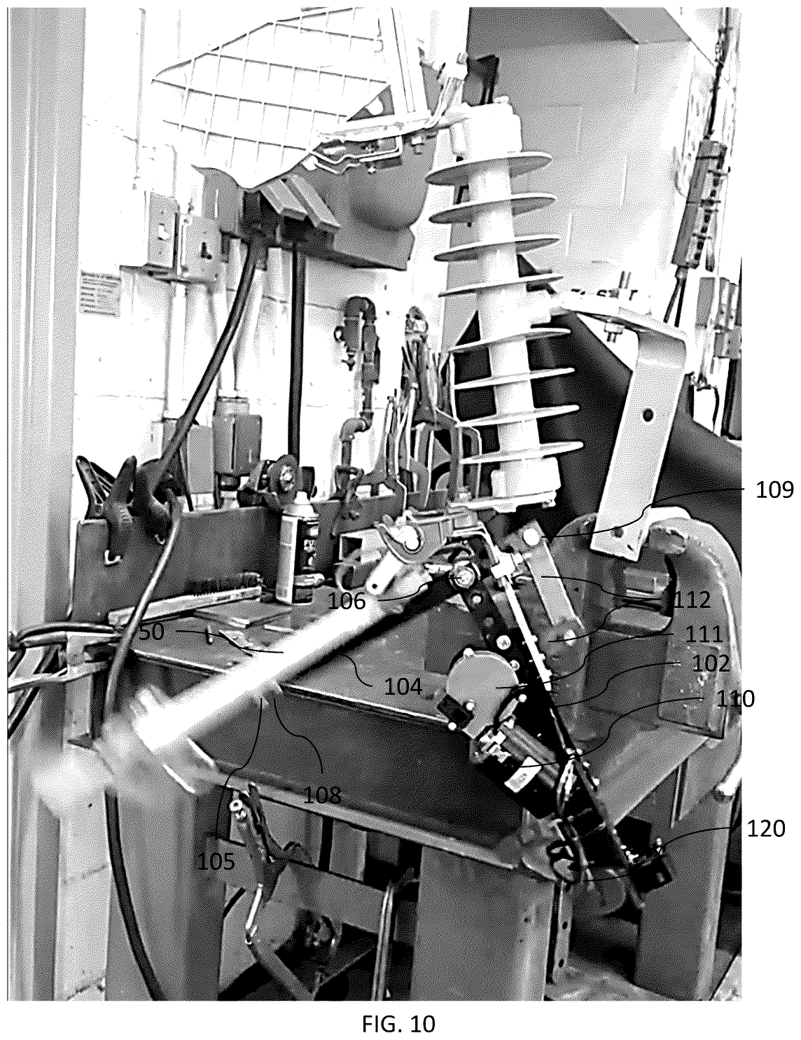

The actuator may comprise a motor 111. As shown in FIGS. 10-12, the motor 111 may be configured to rotate to effect rotation or pivotal movement of the at least one connecting member 112 to pivot the arm 104 thereby moving the fuse tube 50 from the open position to the closed position. The arm 104 and/or at least one connecting member 112 may have an adjustable length to allow the refuser 100 to couple to fuse cutouts 10 having different ampere ratings, and therefore, having different sizes.

A method of closing a fuse cutout 10 using the load break cutout refuser system 1000 comprises sending, by the transmitter 130, a signal 132 to the receiver 120. The method comprises receiving, by the receiver 120, the signal 132. The method also comprises closing, by the actuator 110 in response to the received signal 132, the fuse cutout 10.

Following closing of the fuse cutout 10 as disclosed herein, it is contemplated that the actuator can decouple or disengage from the fuse tube 50 to allow the fuse tube to be secured in the closed position using the same features (e.g., attachment hooks 60). In these aspects, following melting or “blowing” of the fuse, the first end 52 of the fuse tube 50 can still be forced from the attachment hooks 60 and pivot away from the upper contact 34 via the hinge connection 70 so that the fuse tube 50 is in an open position and is hanging from the hinge connection 70, thereby allowing for viewing of the open condition of the fuse cutout.

It is expected that the refuser 100, the system 1000, and the method used for closing a fuse cutout 10 as described herein greatly increases the safety of the technician closing the fuse cutout 10 by significantly mitigating technician exposure to high energy electrical arc flash.

Although the foregoing invention has been described in some detail by way of illustration and example for purposes of clarity of understanding, certain changes and modifications may be practiced within the scope of the appended claims.

What is claimed is:

1. A load break cutout refuser comprising:
an actuator configured to couple to a fuse cutout,
a receiver communicatively coupled to the actuator and configured to receive a signal from a transmitter remote from the receiver,
wherein the actuator is configured to close the fuse cutout in response to the signal received by the receiver.

2. The refuser of claim 1, wherein the actuator is configured to couple to a fuse tube of the fuse cutout.

3. The refuser of claim 2, wherein the actuator is configured to move the fuse tube from an open position to a closed position, wherein the fuse cutout is open and a load current is interrupted when the fuse tube is in the open positions, and the fuse cutout is closed and the load current passes through the fuse cutout when the fuse tube is in the close position.

4. The refuser of claim 3, further comprising:
a body configured to attach to the fuse cutout; and
an arm pivotably attached to the body at a pivot pin;
wherein the actuator is coupled to the body.

5. The refuser of claim 4, wherein the actuator is configured to cause the arm to pivot about the pivot pin.

6. The refuser of claim 5, wherein the arm is coupled to the fuse tube and causes the fuse tube to simultaneously pivot with the arm from the open position to the closed position.

7. The refuser of claim 6, wherein a first end of the arm is configured to couple to the fuse tube and a second end of the arm is coupled to at least one connecting member configured to couple the arm to the actuator, wherein the pivot pin is positioned between the first end and the second end of the arm.

8. The refuser of claim 7, wherein the actuator comprises a motor.

9. The refuser of claim 8, wherein the motor is configured to rotate to effect rotation or pivotal movement of the at least one connecting member to pivot the arm.

10. A load break cutout refuser system comprising:
an actuator configured to couple to a fuse cutout;
a transmitter remote from the fuse cutout; and
a receiver communicatively coupled to the actuator and configured to receive a signal from the transmitter,
wherein the actuator is configured to close the fuse cutout in response to the signal received by the receiver.

11. The refuser of claim 10, wherein the actuator is configured to couple to a fuse tube of the fuse cutout.

12. The refuser of claim 11, wherein the actuator is configured to move the fuse tube from an open position to a closed position, wherein the fuse cutout is open and a load current is interrupted when the fuse tube is in the open positions, and the fuse cutout is closed and the load current passes through the fuse cutout when the fuse tube is in the close position.

13. The refuser of claim 12, wherein the transmitter is a component of a remote control.

14. The refuser of claim 13, further comprising:
a body configured to attach to the fuse cutout; and
an arm pivotably attached to the body at a pivot pin;
wherein the actuator is coupled to the body.

15. The refuser of claim 14, wherein the actuator is configured to cause the arm to pivot about the pivot pin.

16. The refuser of claim 15, wherein the arm is coupled to the fuse tube and causes the fuse tube to simultaneously pivot with the arm from the open position to the closed position.

17. The refuser of claim 16, wherein a first end of the arm is configured to couple to the fuse tube and a second end of the arm is coupled to at least one connecting member configured to couple the arm to the actuator, wherein the pivot pin is positioned between the first end and the second end of the arm.

18. The refuser of claim 17, wherein the actuator comprises a motor.

19. The refuser of claim 18, wherein the motor is configured to rotate to effect rotation or pivotal movement of the at least one connecting member to pivot the arm.

20. A method of closing a fuse cutout using the load break cutout refuser system of claim 10, the method comprising:
sending, by the transmitter, a signal to the receiver;
receiving, by the receiver, the signal; and
closing, by the actuator in response to the received signal, the fuse cutout.
